(19) United States
(12) Patent Application Publication
(10) Pub. No.: US 2026/0285498 A1
(43) Pub. Date: Sep. 24, 2026

(54) ASSEMBLY FOR AIRCRAFT, COMPRISING A SPECIFIC ARCHITECTURE FOR THE DISTRIBUTION OF FUEL COMPOSITION AND ELECTRICITY

(71) Applicant: Airbus SAS, BLAGNAC (FR)

(72) Inventors: Jitendra YADAV, BLAGNAC (FR); Ludovic YBANEZ, BLAGNAC (FR); Souhaib BOUKAYOUA, BLAGNAC (FR); Antoine DELARCHE, BLAGNAC (FR); Francois DUNOYER, BLAGNAC (FR); Camille CHAPER, BLAGNAC (FR)

(21) Appl. No.: 19/567,471

(22) Filed: Mar. 16, 2026

(30) Foreign Application Priority Data
Mar. 18, 2025 (FR) FR2502760

(51) Int. Cl. B64D 37/30; B64D 27/31; B64D 27/34; B64D 27/355; B64D 37/34; F17C 7/02; H01M 8/04014; H01M 8/04082

(52) U.S. Cl. CPC B64D 37/30; B64D 27/31; B64D 27/34; B64D 27/355; B64D 37/34; F17C 7/02; H01M 8/04014; H01M 8/04201; F17C 2221/012; F17C 2223/0161; F17C 2265/066; F17C 2270/0189; H01M 2250/20

(57) ABSTRACT

An aircraft including an assembly of at least one wing provided with at least one propulsion structure, referred to as a pod, and a fuselage. The assembly includes a hot zone, including elements at hot temperatures, greater than or equal to a hot zone temperature, and a cold zone, including elements at cold temperatures, less than or equal to a cold zone temperature, the hot zone and the cold zone being distinct from each other, and the cold zone temperature being strictly lower than the hot zone temperature. An electricity generation system is located in the hot zone, and at least one fuel composition storage tank for supplying the electricity generation system is located in the cold zone. An electric propulsion unit includes a motor and a motor control unit configured to be electrically powered by the electricity generation system to produce thrust.

This application claims the benefit of the French Application No. FR2502760 filed on Mar. 18, 2025, the entire disclosures of which are incorporated herein by way of reference.

### FIELD OF THE INVENTION

The present invention relates to an aircraft, for example a hydrogen-propelled aircraft, comprising a specific architecture for the distribution of fuel composition and electricity.

### BACKGROUND OF THE INVENTION

To reduce the climate impact of aviation, the applicant has developed aircraft designs with hydrogen-propelled motors. Specific equipment has to be developed to improve the competitiveness of this type of propulsion. The present invention is intended to improve the current situation in this regard.

### SUMMARY OF THE INVENTION

For this purpose, an aircraft is proposed, comprising an assembly of at least one wing provided with at least one propulsion structure, referred to as a pod, and a fuselage, the assembly comprising a zone, referred to as the hot zone, including elements at temperatures, referred to as hot temperatures, greater than or equal to a temperature, referred to as the hot zone temperature, and another zone, referred to as the cold zone, including elements at temperatures, referred to as cold temperatures, less than or equal to a temperature, referred to as the cold zone temperature, the hot zone and the cold zone being distinct from each other, and the cold zone temperature being strictly lower than the hot zone temperature, an electricity generation system being located in the hot zone, and at least one fuel composition storage tank for supplying the electricity generation system being located in the cold zone, and an electric propulsion unit including a motor and a motor control unit configured to be electrically powered by the electricity generation system to produce thrust.

Thus, the separation between the hot zone and the cold zone reduces weight, improves safety, maintenance, operations, reduces the risk of failure, simplifies the manufacture of the aircraft, reduces the footprint of cooling systems of the power train and elements of the hydrogen propulsion system and simplifies the integration of the various mechanical, electrical and thermal systems of the aircraft. In particular, the invention brings the cold source closer to the elements of the power train, which ensures efficient cooling with reduced complexity and a modular design. This makes it possible to increase the number of passengers the aircraft can accommodate without having to change the current design of aircraft models.

According to another aspect, the temperature of the cold zone is cryogenic.

According to another aspect, the electricity generation system comprises at least one fuel cell.

According to another aspect, the hot zone comprises at least one aft portion of the fuselage.

According to another aspect, an air supply system and/or a thermal management system and/or a cooling air inlet and/or a non-propulsive energy source and/or a set of auxiliary components for the electricity generation system are located in the hot zone.

According to another aspect, the cold zone comprises the at least one pod.

According to another aspect, the electric propulsion unit and/or the cold box and/or fuel composition distribution lines are located in the cold zone.

According to another aspect, the motor is superconducting and the control unit operates at a cryogenic temperature.

EWIS electrical interconnection cables between the hot zone and the cold zone are superconducting.

### BRIEF DESCRIPTION OF THE DRAWINGS

Other features, details and advantages will appear from reading the detailed description below, and from analyzing the attached drawings, in which:

FIG. 1 is a schematic perspective view provided with an architecture according to an embodiment of the present invention.

FIG. 2 is a top view of the aircraft provided with the architecture in FIG. 1, visible by transparency.

FIG. 3 is a block diagram of the systems of the architecture in FIG. 1.

FIG. 4 is a high-level diagram of a simplified functional architecture of the superconducting cryogenic technology in FIG. 1.

FIG. 5 is a high-level diagram of a simplified functional architecture of the technology in FIG. 1 according to an alternative embodiment, including a tank GH2 in a tail cone, for example for ground operations, notably when starting fuel cells and the power train, as detailed below.

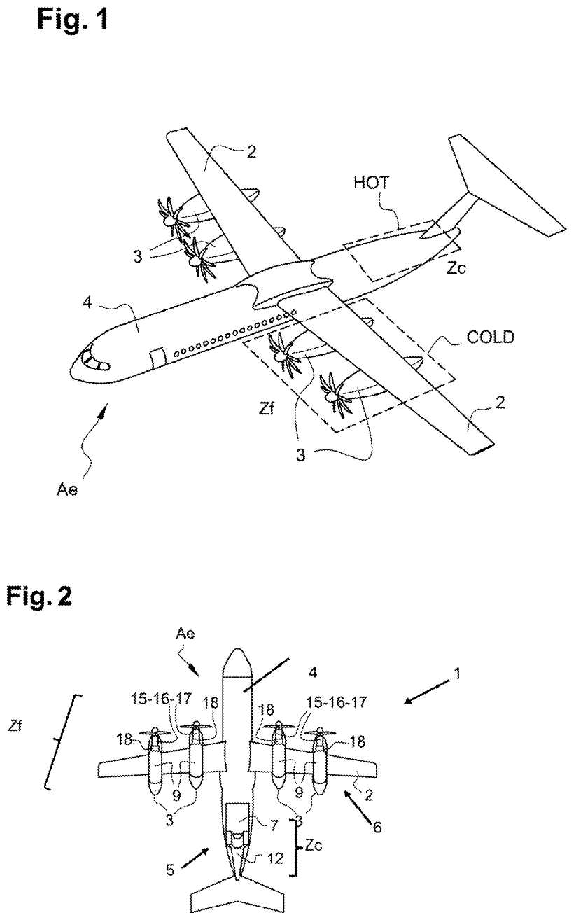

### DETAILED DESCRIPTION OF THE PREFERRED EMBODIMENTS

The examples and the related conditions detailed here are mainly intended to help the reader understand the principles of the present invention and not to limit its scope to these specific examples and conditions. It will be understood that a person skilled in the art can conceive of various arrangements which, although not explicitly described or represented here, nevertheless embody the principles of the present invention and are included in its spirit and scope.

Furthermore, to facilitate understanding, the following description may describe relatively simplified implementations of the present invention. As a person skilled in the art will understand, other implementations of the present invention may be of greater complexity.

In some cases, examples of modifications of the present invention may also be presented. This is done simply to aid understanding, again rather than define the scope or establish the limits of the present invention. These modifications are not an exhaustive list, and a person skilled in the art may make other modifications while still remaining within the scope of the present invention.

Furthermore, all the statements below relating to the principles, aspects and implementations of the present invention, as well as the specific examples thereof, aim to encompass both the structural and functional equivalents thereof, whether they are currently known or developed in the future.

To facilitate comprehension, the patent application refers to hydrogen or dihydrogen, it being understood that the molecule is dihydrogen H2.

As shown in the figures, the invention relates to a manned or unmanned aircraft Ae of any configuration.

In the following description, the aircraft is electrically propelled. Electric propulsion means all electric aircraft (AEA), hybrid electric aircraft (HEA) or more electric aircraft (MEA).

In the following description, the aircraft Ae is hydrogen-propelled. Nevertheless, the invention is not limited to hydrogen, and other fuel compositions are conceivable, such as methane, for example.

In the following description, the assembly comprises at least one fuel cell. Nevertheless, the invention is not limited to this type of electricity generation system and more broadly, the invention covers different types of electricity generation systems (conventional and/or non-conventional) such as batteries, or types of motors powering electric turbines/gas turbines that can burn any fuel, including liquid hydrogen, for example.

The aircraft Ae comprises an assembly 1 of at least one wing 2 provided with at least one propulsion structure 3 and a fuselage 4. The structure 3 is also referred to as a pod. Thus, the term pod shall be understood as any container that carries a motor, and possibly other components, such as a fuel tank for example. In this new architecture as described below, the pod contains the electric hydrogen propulsion system (due to the fact that an LH2 tank, a cold box, a superconducting motor and a motor control unit (MCU) as detailed below, are in the pod).

The assembly 1 comprises a first zone, referred to as the hot zone, referenced Zc. The zone Zc comprises the power generation, i.e., the power generation system, such as a fuel cell.

The hot zone Zc includes elements 5 exhibiting (i.e., operating at), during all phases of flight, temperatures, referred to as hot temperatures, greater than or equal to a temperature, referred to as the hot zone temperature, Tc.

The assembly 1 also comprises a second zone, referred to as the cold zone Zf. The cold zone Zf includes elements 6 exhibiting temperatures, referred to as cold temperatures, lower than or equal to a temperature, referred to as the cold zone temperature, Tf during all phases of flight or even when stationary. The temperature Tf is strictly lower than the temperature Tc.

The temperature Tf is cryogenic, i.e. less than or equal to −150° C.

The temperature Tf is for example less than or equal to 120 K, for example between 15 K and 120 K. The temperature Tc is for example greater than or equal to 220 K, for example between 220 K and 380 K.

The hot zone Zc and the cold zone Zf are distinct from each other, as detailed below.

The hot zone Zc comprises at least one aft portion of the fuselage.

The cold zone Zf comprises the at least one pod 3. In the figures, the cold zone Zf comprises four pods 3.

The central portion is the portion of the fuselage 4 level with the wing box (WB). The aft portion is to the rear of the central portion and extends from the wing box. The tail cone is the rearmost portion of the aft portion of varying cross section where the tail surfaces are located.

The elements 5 in the hot zone Zc include at least one fuel cell FC, referenced 7 enabling electrical distribution 8 (PGS for power generating system). The PGS 8 comprises the at least one fuel cell and BOP components, explained below. The elements 6 in the cold zone Zf include at least one tank 9 for storing hydrogen, advantageously in liquid form (LH2), to supply the fuel cell FC, 7.

As shown in the figures, the hot zone Zc comprises an air supply system (ASS), a thermal management system 11 (TMS), and a cooling air inlet 12 (RAC for ram air cooling), a non-propulsive energy source 13 (NPE) and auxiliary components 14 (BOP for balance of plant) that enable the fuel cells to operate. In some configurations, it may be possible to have other types of components offering the same functionality. In this case, only some of the components listed above could be in the hot zone in combination with other components.

As also shown in the figures, the cold zone Zf, in the at least one pod 3, comprises an electric propulsion unit (EPU) 16 comprising a motor 15 configured to be electrically powered by the fuel cell 7, a motor control unit 17 (MCU), a system for keeping the motor 15, the tank 9 at cryogenic temperature, a cold box 18, comprising, for example, an LH2/GHe heat exchanger and a closed GHe cryogenic loop (cryofan, valves, etc.). In some configurations, it may be possible to have other types of components offering the same functionality. Again, only some of the components listed above could be in the cold zone in combination with other components.

As also shown in the figures, there are fuel composition distribution lines 90 between the cold zone Zf and the hot zone Zc, for example cryogenic hydrogen gas GH2 distribution lines for supplying the fuel cells, as well as electrical wiring interconnection cables 21 (EWIS or electrical wiring interconnexion system lines), which can for example be superconducting DC electrical distribution to electrically power the EPU. The electrical distribution and fuel composition lines run through the pod, the wing, the wing box and the aft portion of the fuselage.

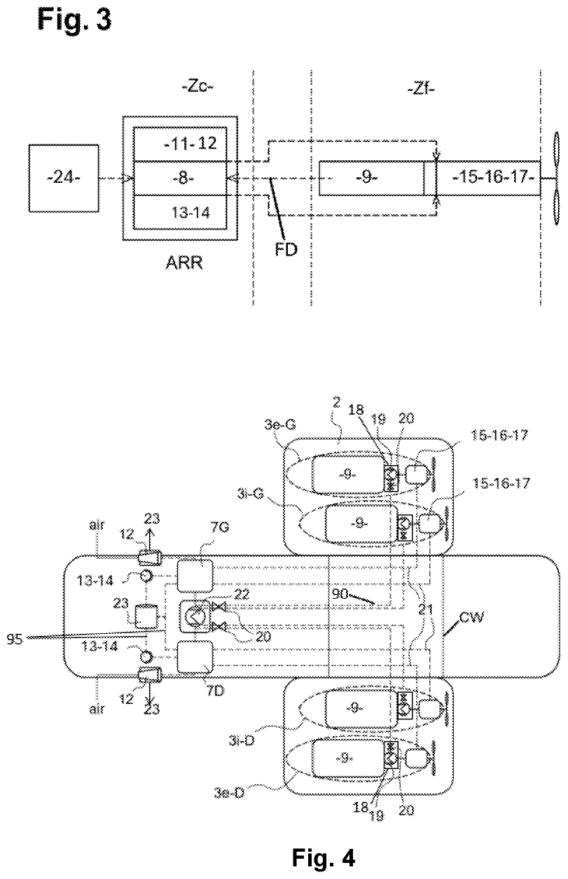

FIG. 3 shows the distribution of fuel between the tank 9 and the PGS 8 in dashed lines with reference sign FD.

The simplified electrical architecture is described in detail below with reference to FIG. 4.

In FIG. 4, the aircraft Ae comprises four pods, two pods per wing, referred to respectively as the inner pod 3i-G and outer pod 3e-G of the left wing, and the inner pod 3i-D and outer pod 3e-D of the right wing. An inner pod is closer to the fuselage than the respective outer pod. In an arbitrary and non-constraining manner, a wing of the aircraft to the left of the fuselage for an observer facing the nose of the aircraft is referred to as the left wing.

The elements are described in a direction of flow of the hydrogen fluid from its storage to the fuel cell.

As shown in this figure, each of the pods comprises a tank 9 for storing hydrogen in liquid form, at a cryogenic temperature Tcy, as well as an EPU 16 at a cryogenic temperature Tcx greater than or equal to Tcy. A liquid hydrogen distribution line connects the tank 9 to a first exchanger 19 along with a valve 20 for opening and closing the tank arranged downstream of the first exchanger 19. The first exchanger 19 advantageously allows the liquid hydrogen to be heated by another fluid, such as helium in the gaseous phase GHe or another type of cryogen (such as LN2 or a mixture of cryogenic gases), and to subject the liquid hydrogen coming from the tank 9 to a liquid-gas phase change at a cryogenic gas phase temperature. The heat dissipated from the EPU exhibiting a cryogenic temperature and electrical distribution lines is used in exchanger 19 to heat the hydrogen LH2 via a GHe cryocooling loop of the power train. The hydrogen gas from the outlet of the exchanger 19 supplies the fuel cells to produce the necessary power, which is distributed through EWIS electrical lines 21, for example in the form of superconducting cables. The electrical power generated by the fuel cells is distributed through the EWIS lines to the four structures on each wing and more precisely to the EPUs in each propulsion structure to provide the required thrust.

The first exchanger 19 and the valve 20 are advantageously arranged in the pod and more specifically in the cold box 18.

It should be noted that the motor 15 is advantageously a superconducting motor.

The cold box 18 is a box containing the LH2/GHe exchanger 19, the GHe loop extracting the heat and cryo-components used to circulate the liquid hydrogen and the GHe to cool the EPU unit to cryogenic temperature, notably on account of the superconducting components.

Thus, in each pod, the cold box 18 is associated with a liquid hydrogen storage tank 9.

The fuselage 4 comprises a heat exchanger 22 for heating the cryogenic gaseous hydrogen coming from the pod through the distribution lines 90, using another fluid. The other fluid is a coolant liquid, for example ethylene glycol water (EGW). In FIG. 4, the heat exchanger 22 (for example EGW/GH2) is fluidically connected at the rear of the fuselage to the four liquid hydrogen storage tanks, by distribution lines 90 optionally provided with regulating valves 20 (two illustrated in FIG. 4).

The hydrogen distribution lines and the EWIS lines coming from the cold zone pass successively through the wing, the wing box and the aft portion of the fuselage.

As also shown in FIG. 4, the fuselage 4 comprises a thermodynamic loop relating to the coolant fluid, for example ethylene glycol, including a tank 23 for storing the coolant liquid, for example, ethylene glycol and ethylene glycol distribution lines 95 to cool the power generation systems and their auxiliary components. Once extracted from the fuel cells, the heat is dissipated by the coolant liquid into a coolant liquid/air exchanger in the RAC 12.

The fuselage 4 also houses at least one fuel cell FC 7, as already indicated. In FIG. 4, the fuselage comprises two fuel cells (this number being not limiting), each of the fuel cells being supplied with hydrogen via an outlet of the exchanger 22. The fuel cells are, for example, proton-exchange-membrane fuel cells, either low-temperature or high-temperature, and/or solid-oxide fuel cells.

As shown in FIG. 4, the fuel cells 7 are fluidically connected to the tank of coolant liquid, for example EGW 23. The coolant liquid is used to cool the fuel cells 7 as well as the auxiliary components 14 (BOP), the air supply system (ASS) and the non-propulsive energy source 13 (NPE).

The auxiliary components cooled by the coolant liquid dissipate the heat to heat the hydrogen and the missing heat is produced by the fuel cells. The mission-profile-based heat management system extracts the heat from the fuel cell to further heat the hydrogen to the working temperature of the fuel cell.

The fuselage 4 also comprises at least one cooling system for the coolant liquid, for example the EGW, coming from the fuel cell using air or RAC 12 (ram air cooling). In FIG. 4, an RAC system is associated with each of the fuel cells. It should be noted that the RAC can be positioned wherever desired in the fuselage and the wings according to aerodynamic design principles. The fuselage also comprises a distribution line to return the EGW air-cooled in the RAC to the storage tank 23.

The fuselage 4 comprises EWIS electrical interconnection cables 21 distributing electrical current generated by the fuel cells to the EPU including the motor and the MCU. In FIG. 4, one of the fuel cells, referred to as the left cell 7-G, supplies the EPUs of the left wing, and the other fuel cell, referred to as the right cell 7-D, supplies the EPUs of the right wing.

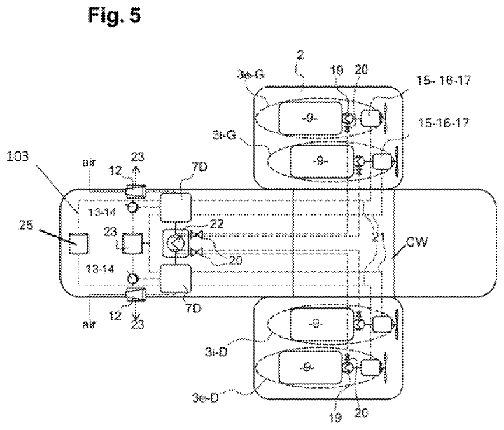

In the variant in FIG. 5, the aircraft comprises, in addition to the architecture detailed in relation to FIG. 4, in its tail cone, a gaseous hydrogen tank 25, as well as distribution lines 103, to supply the left and right fuel cells with gaseous hydrogen at high pressure, for example 700 bar, to generate electricity for ground operations. The temperature of the zone is advantageously greater than 273 K. The fuel cells and the GH2 act as an auxiliary power unit (APU) for at least one minute.

In terms of temperature, the hydrogen at the inlet of the first LH2/GHe exchanger 19 is at a temperature advantageously between 15 K and 20 K, for example, and at the outlet of the first exchanger 19 between 60 K and 120 K, for example. The temperature of the helium at the inlet of the first exchanger 19 is advantageously between, for example, 60 K and 120 K, and between, for example, 20 K and 30 K at the outlet of the first exchanger 19. The temperature of the helium at the EPU (superconducting motor and MCU at cryogenic temperature), in the cold box 18, is advantageously between 20 K and 120 K.

By way of non-limiting example, the temperature of the gaseous hydrogen GH2 at the inlet of the second exchanger is advantageously between, for example, 60 K and 120 K, and, at the outlet, between, for example, 278 K and 378 K, whereas the temperature of the GWE is advantageously between, for example, 278 K and 378 K at the inlet of the second exchanger, and between, for example, 233 K and 328 K at the outlet of the second exchanger.

As is already apparent at least partially from the preceding description, it should be noted that the present architecture provides:
a separate storage tank for each pod, which simplifies decoupling from the LH2 and the fuselage, and moves it away from the passengers by locating it in the wings,
distribution of the hydrogen and the electric current in opposite directions: the hydrogen flows towards the rear of the aircraft, from the pods to the aft portion, while the electric current flows towards the front of the aircraft, from the aft portion to the pods,
a central arrangement of the fuel cells in the fuselage, on account of the separation of the hot and cold zones,
ease of integration, maintenance and operations on account of the modular configuration of the separation of the hot and cold zones.

The architecture with separation of the cold and hot zones has the following advantages:
safety isolation,
increase in the number of passengers,
no major modifications required in the aircraft layout,
increase in load capacity,
better distribution of hydrogen and electric current,
greater compactness,
improvement and simplification of the layout of the pod, due to the greater compactness,
a reduction in weight and drag,
maintenance and technical operations simpler to carry out on account of the configuration in hot and cold modules,
noise reduction,
balanced LH2 distribution and thrust,
simplified refueling of liquid hydrogen.

Modifications and improvements to the implementations described above of the present invention may occur to a person skilled in the art.

The above description is illustrative by means of examples rather than limiting. The scope of the present invention is therefore limited solely by the scope of the claims below.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Moreover, throughout this document including the claims, expressions such as “at least one of”, or “one or more of”, when preceding a list of elements, modify the entire list of elements and do not modify the individual elements of the list.

1. An aircraft, comprising:
an assembly of:
at least one wing provided with at least one propulsion structure, referred to as a pod, and
a fuselage,
a zone, referred to as a hot zone, including elements at temperatures, referred to as hot temperatures, greater than or equal to a temperature, referred to as a hot zone temperature, and another zone, referred to as a cold zone, including elements at temperatures, referred to as cold temperatures, less than or equal to a temperature, referred to as a cold zone temperature, the hot zone and the cold zone being distinct from each other, and the cold zone temperature being lower than the hot zone temperature,
an electricity generation system being located in the hot zone, and
at least one fuel composition storage tank for supplying said electricity generation system being located in the cold zone, and
an electric propulsion unit including a motor and a motor control unit configured to be electrically powered by the electricity generation system to produce thrust.

2. The aircraft according to claim 1, wherein the temperature of the cold zone is cryogenic.

3. The aircraft according to claim 1, wherein the electricity generation system comprises at least one fuel cell.

4. The aircraft according to claim 1, wherein the hot zone comprises at least an aft portion of the fuselage.

5. The aircraft according to claim 1, wherein at least one of:
an air supply system;
a thermal management system;
a cooling air inlet;
a non-propulsive energy source; or
a set of auxiliary components for the electricity generation system;
are located in the hot zone.

6. The aircraft according to claim 1, wherein the cold zone comprises said at least one pod.

7. The aircraft according to claim 1, wherein at least one of the electric propulsion unit, a cold box, or fuel composition distribution lines are located in the cold zone.

8. The aircraft according to claim 1, wherein the motor is superconducting and the control unit operates at a cryogenic temperature.

9. The aircraft according to claim 1, wherein EWIS electrical interconnection cables between the hot zone and the cold zone are superconducting.
